(19) United States
(12) Patent Application Publication
(10) Pub. No.: US 2014/0256875 A1
(43) Pub. Date: Sep. 11, 2014

(54) PROCESS FOR PREPARING AMORPHOUS POLYESTER HOT MELT ADHESIVE WITH LOW MELTING POINT

(71) Applicants: Shanghai TianYang Hot Melt Adhesive Co., Ltd., Shanghai (CN); Kunhan TianYang hot Melt Adhesive Co., Ltd., Jiangsu (CN); East China University of Science and Technology, Shanghai (CN)

(72) Inventors: Zhelong Li, Shanghai (CN); Wanyu Zhu, Shanghai (CN); Zhiyan Ma, Shanghai (CN); Zuoxiang Zeng, Shanghai (CN); Tao Han, Shanghai (CN)

(73) Assignees: Kunshan Tianyang Hot Melt Adhesive Co., Ltd.; Shanghai Tianyang Hot Melt Adhesive Co., Ltd.; East China University of Science and Technology

(21) Appl. No.: 14/355,534

(22) PCT Filed: May 31, 2013
(86) PCT No.: PCT/CN2013/076571

§ 371 Date: Apr. 30, 2014

(30) Foreign Application Priority Data
Jun. 16, 2012 (CN) 201210201944.6

(51) Int. Cl. C09J 167/02

(52) U.S. Cl. CPC C09J 167/02
USPC 524/710; 524/878

(57) ABSTRACT

A method of preparing an amorphous, low-melting-point polyester hot-melt adhesive is disclosed. The method includes the steps of: 1) esterifying terephthalic acid, isophthalic acid and an aliphatic dicarboxylic acid with ethylene glycol and a C₃-C₆ dial in a presence of an esterification catalyst; 2) adding a stabilizer, a polycondensation catalyst and an antioxidant to a product from step 1) and lowering the pressure to perform a polycondensation reaction which results in a polyester having a melting point of lower than 120° C. The polyester hot-melt adhesive of the invention assumes a transparent state with no crystallization both in normal-temperature and high-temperature conditions and has a high flowability and an excellent wettability in low-temperature applications.

### TECHNICAL FIELD

The present invention relates to methods of preparing an amorphous polyester hot-melt adhesive with low melting point.

BACKGROUND

Known polyester hot-melt adhesives are mostly produced by the esterification of diols and aromatic dicarboxylic acids such as benzene dicarboxylic acids, or long-chain aliphatic dicarboxylic acids, or transesterification between diols and dimethyl esters of these dicarboxylic acids, and subsequent polycondensation.

However, as polyester hot-melt adhesives made in such way typically have a high viscosity and high proneness to crystallization, they cannot be suitably used in light-color garment, sofas and other articles of daily use. Moreover, their rapid crystallizing nature creates great difficulties in controlling their coating time and speed.

### SUMMARY OF THE INVENTION

An objective of the present invention is to provide a method of preparing an amorphous, low-melting-point polyester hot-melt adhesive. The method includes:

1) esterifying terephthalic acid, isophthalic acid and an aliphatic dicarboxylic acid with ethylene glycol and a C₃-C₆ diol in a presence of an esterification catalyst with water produced from the esterification reaction removed by distillation, wherein the esterification reaction is performed at a temperature of 150° C.˜250° C. and terminated upon an amount of the distilled water reaching 90˜95% of a calculated amount;

2) adding a stabilizer, a polycondensation catalyst and an antioxidant to a product of the esterification reaction of step 1) to perform a polycondensation reaction at a temperature of 250° C.˜260° C. and a pressure of 100 Pa˜133 Pa to generate a polyester; and

3) cooling the polyester from step 2) to form the amorphous, low-melting-point polyester hot-melt adhesive as a transparent bar.

The aliphatic dicarboxylic acid is one or more selected from the group consisting of 1,6-adipic acid, 1,10-sebacic acid and 1,12-dodecanedioic acid; the C₃˜C₆ diol is one or more selected from the group consisting of 1,4-butanediol, 1,5-pentanediol, 1,6-hexanediol and diethylene glycol; a ratio of a total molar amount of the terephthalic acid, the isophthalic acid and the aliphatic dicarboxylic acid to a total molar amount of the ethylene glycol and the C₃˜C₆ diol is 1:1.2˜2.0; the terephthalic acid, the isophthalic acid and the aliphatic dicarboxylic acid are in a molar ratio of 1:0.1875˜0.125:0.0625˜0.125; a molar ratio of the ethylene glycol to the C₃˜C₆ diol is 1:0.25˜0.43; and the stabilizer is selected from trimethyl phosphate and triphenyl phosphite, and the stabilizer is used in an amount that is 0.05%˜0.15% by weight of the total of the terephthalic acid, the isophthalic acid and the aliphatic dicarboxylic acid.

The antioxidant is selected from antioxidant 285 and antioxidant 1010, and the antioxidant is used in an amount that is 0.10%˜0.24% by weight of the total of the terephthalic acid, the isophthalic acid and the aliphatic dicarboxylic acid.

The esterification catalyst and the polycondensation catalyst are each selected from the group consisting of tetrabutyl titanate, tetraisopropyl titanate and tetraethyl titanate, and a total weight of the esterification catalyst and the polycondensation catalyst is 0.066%˜0.2% of a total weight of the terephthalic acid, the isophthalic acid and the aliphatic dicarboxylic acid.

The polyester hot-melt adhesive of the invention assumes a transparent state with no crystallization both in normal-temperature and high-temperature conditions and has a high flowability and an excellent wettability in low-temperature applications.

### DETAILED DESCRIPTION

Performance Test: the weight-average molecular weights of the products obtained from the Examples of the present invention were measured by gel permeation chromatography. The melting points and melt flow rate (MFR's) were measured according to ISO 11357-1-1997 and the Chinese National Standard GB/T 3682-2000, respectively. The contact angle referred to a measured angle between a hot-melt adhesive surface and water at 20° C., and the degree of crystallinity was determined as a ratio of its DSC (Differential Scanning Calorimetry)-measured value after the sample had been kept at a constant temperature of 50° C. for 10 hours to that of polyethylene terephthalate (PET).

All materials and reagents used in adhesive preparation were commercially available ones.

### EXAMPLE 1

After 166 g (1 mol) of terephthalic acid, 31.1 g (0.187 mol) of isophthalic acid, 9.1 g (0.0623 mol) of 1,6-adipic acid, 89.3 g (1.44 mol) of ethylene glycol, 28.6 g (0.27 mol) of diethylene glycol, 9.4 g (0.090 mol) of 1,5-pentanediol and 0.11 g of tetrabutyl titanate were added to a 2000 ml glass reactor equipped with a thermometer, a powerful stirrer, a fractionation column and a reflux condenser, the stirrer was activated and the reactor was heated. Once the temperature was increased to about 180° C., water began to distill with a temperature of 95° C.˜105° C. Afterward, the temperature in the reactor was further increased slowly to about 220° C. and maintained thereat. When the amount of the distilled water reached 90% of an amount of calculation, the esterification reaction was terminated, followed by the further addition of 0.103 g of trimethyl phosphate as a stabilizer, 0.18 g of antioxidant 1010 and 0.10 g of tetrabutyl titanate as a polycondensation catalyst to the reactor. The reactor was then heated gradually to a temperature of about 250° C. and was thereafter depressurized by a vacuum pump to a pressure of 100 Pa˜133 Pa to initiate a polycondensation reaction. With the pressure kept constant, the reaction was run for about 2 hours at the temperature of 250° C.˜260° C. and terminated thereafter. The reactor was devacuumed and the resulting melt was poured, before being air-cooled, into cold water, thereby resulting in a transparent adhesive bar, which was subsequently pelletized to produce an inventive amorphous, low-melting-point polyester hot-melt adhesive.

The adhesive was measured to have a melting point of 107° C., an MFR of 36 g/10 min, a weight-average molecular weight of 32,000, a contact angle of 58.3° and a degree of crystallinity of 0.1%.

### EXAMPLE 2

After 166 g (1 mol) of terephthalic acid, 20.8 g (0.125 mol) of isophthalic acid, 18.3 g (0.125 mol) of 1,6-adipic acid, 89.3 g (1.44 mol) of ethylene glycol, 19 g (0.18 mol) of diethylene glycol, 18.7 g (0.18 mol) of 1,5-pentanediol and 0.22 g of tetrabutyl titanate were added to a 2000 ml glass reactor equipped with a thermometer, a powerful stirrer, a fractionation column and a reflux condenser, the stirrer was activated and the reactor was heated. Once the temperature was increased to about 180° C., water began to distill with a temperature of 95° C.˜105° C. Afterward, the temperature in the reactor was further increased slowly to about 220° C. and maintained thereat. When the amount of the distilled water reached 95% of an amount of calculation, the esterification reaction was terminated, followed by the further addition of 0.25 g of trimethyl phosphate, 0.492 g of antioxidant 1010 and 0.20 g of tetrabutyl titanate to the reactor. The reactor was then heated gradually to a temperature of about 250° C. and was thereafter depressurized by a vacuum pump to a pressure of lower than 133 Pa to initiate a polycondensation reaction. As with the pressure kept constant, the reaction was run for about 1.5 hours at the temperature of 250° C.˜260° C. and terminated thereafter. With the termination of the reaction, the reactor was devacuumed and the resulting melt was poured, before being air-cooled, into cold water, thereby resulting in a transparent adhesive bar, which was subsequently pelletized to produce an inventive amorphous, low-melting-point polyester hot-melt adhesive.

The adhesive was measured to have a melting point of 110° C., an MFR of 22 g/10 min, a weight-average molecular weight of 35,000, a contact angle of 56.7° and a degree of crystallinity of 0.1%.

### EXAMPLES 3-6

The Examples were performed in the same steps and conditions of Example 2 but with different materials and amounts, which were presented in the Table 1.

### COMPARATIVE EXAMPLE 1

After 166 g (1 mol) of terephthalic acid, 13.1 g (0.079 mol) of isophthalic acid, 2.1 g (0.014 mol) of 1,6-adipic acid, 99.0 g (1.6 mol) of ethylene glycol, 3.6 g (0.034 mol) of diethylene glycol and 0.11 g of tetrabutyl titanate were added to a 2000 ml glass reactor equipped with a thermometer, a powerful stirrer, a fractionation column and a reflux condenser, the stirrer was activated and the reactor was heated. Once the temperature was increased to about 180° C., water began to distill with a temperature of 95° C.˜105° C. Afterward, the temperature in the reactor was further increased slowly to about 220° C. and maintained thereat. When the amount of the distilled water reached 90% of an amount of calculation, the esterification reaction was terminated, followed by the further addition of 0.103 g of triniethyl phosphate as a stabilizer, 0.18 g of antioxidant 1010 and 0.20 g of tetrabutyl titanate as a polycondensation catalyst to the reactor. The reactor was then heated gradually to a temperature of about 250° C. and was thereafter depressurized by a vacuum pump to a pressure of 100 Pa˜133 Pa to initiate a polycondensation reaction. As with the pressure kept constant, the reaction was run for about 2 hours at the temperature of 250° C.˜260° C. and terminated thereafter. With the termination of the reaction, the reactor was devacuumed and the resulting melt was poured, before being air-cooled, into cold water, thereby resulting in a transparent adhesive bar, which was subsequently pelletized to form an amorphous, low-melting-point polyester hot-melt adhesive.

The adhesive was measured to have a melting point of 137° C., an MFR of 26 g/10 min, and a weight-average molecular weight of 31,000. Table 1 also provides a comparison of characteristics of the adhesives prepared in Examples 3-6 and Comparative Example 1.

TABLE 1
Materials used in Examples 3-6 and Comparative Example 1 and amounts
thereof, as well as comparison of characteristics of prepared adhesives

| | | | | | Comparative |
|---|---|---|---|---|---|
| Material | Example 3 | Example 4 | Example 5 | Example 6 | Example 1 |
| Terephthalic | 0.8 | 0.78 | 0.77 | 0.75 | 1.0 |
| acid (mol) | | | | | |
| Isophthalic | 0.15 | 0.22 | 0.18 | 0.2 | 0.079 |
| acid (mol) | | | | | |
| 1,6-Adipic | 0.05 | | | | 0.014 |
| acid (mol) | | | | | |
| 1,10-Sebacic | | | 0.05 | | |
| acid (mol) | | | | | |
| Dodecanedioc | | | | 11.5 | |
| acid (mol) | | | | | |
| Ethylene | 1.35 | 1.067 | 1.35 | 1.44 | 1.6 |
| glycol (mol) | | | | | |
| 1,4-Butanediol | 0.091 | | | | |
| (mol) | | | | | |
| 1,5-Pentanediol | | | 0.09 | | |
| (mol) | | | | | |
| 1,6-Hexanediol | | 0.58 | | | |
| (mol) | | | | | |
| Diethylene | 0.36 | 0.3 | 0.36 | 0.34 | 0.034 |
| glycol (mol) | | | | | |
| Trimethyl | 0.215 | | | | |
| phosphate (g) | | | | | |
| Triphenyl | | 0.166 | 0.20 | 0.238 | |
| phosphite (g) | | | | | |
| Antioxidant | 0.165 | 0.22 | 0.24 | | |
| 285 (g) | | | | | |
| Antioxidant | | | | 0.2 | |
| 1010 (g) | | | | | |
| Tetraethyl | 0.06^{a} + 0.05^{b} | | | | |
| titanate (g) | | | | | |
| Tetraisopropyl | | 0.20^{a} + 0.13^{b} | | | |
| titanate (g) | | | | | |
| Tetrabutyl | | | 0.12^{a} + 0.08^{b} | 0.16^{a} + 0.14^{b} | 0.11^{a} + 0.20^{b} |
| titanate (g) | | | | | |
| MFR | 74 | 28.6 | 35.3 | 67.2 | 26 |
| (g/10min) | | | | | |
| Melting point | 112 | 114 | 118 | 110 | 137 |
| (° C.) | | | | | |
| Weight- | 28000 | 33500 | 35000 | 29500 | 31000 |
| average mole- | | | | | |
| cular weight | | | | | |
| Contact | 58.1 | 55.4 | 60.1 | 61.0 | 79.2 |
| angle (°) | | | | | |
| Degree of | 0.03 | 0.07 | 0.12 | 0.11 | 43.9 |
| crystallinity (%) | | | | | |

^{a}: amount added as an esterification catalyst
^{b}: amount added as a polycondensation catalyst.

What is claimed is:

1. A method of preparing an amorphous, low-melting-point polyester hot-melt adhesive, comprising the steps of:
1) esterifying terephthalic acid, isophthalic acid and an aliphatic dicarboxylic acid with ethylene glycol and a C₃˜C₆ diol in a presence of an esterification catalyst with water produced from the esterification reaction removed by distillation, wherein the esterification reaction is performed at a temperature of 150° C.˜250° C. and terminated upon an amount of the distilled water reaching 90˜95% of a calculated amount;
2) adding a stabilizer, a polycondensation catalyst and an antioxidant to a product of the esterification reaction of step 1) to perform a polycondensation reaction at a temperature of 250° C.˜260° C. and a pressure of 100 Pa˜133 Pa to generate a polyester; and
3) cooling the polyester from step 2) to form the amorphous, low-melting-point polyester hot-melt adhesive as a transparent bar,
wherein the aliphatic dicarboxylic acid is one or more selected from the group consisting of 1,6-adipic acid, 1,10-sebacic acid and 1,12-dodecanedioic acid;
wherein the C₃˜C₆ diol is one or more selected from the group consisting of 1,4-butanediol, 1,5-pentanediol, 1,6-hexanediol and diethylene glycol,
wherein a ratio of a total molar amount of the terephthalic acid, the isophthalic acid and the aliphatic dicarboxylic acid to a total molar amount of the ethylene glycol and the C₃˜C₆ diol is 1:1.2˜2.0;
wherein the terephthalic acid, the isophthalic acid and the aliphatic dicarboxylic acid are in a molar ratio of 1:0.125˜0.1875:0.0625˜0.1.25;
wherein a molar ratio of the ethylene glycol to the C₃˜C₆ diol is 1:0.25˜0.43; and
wherein the esterification catalyst and the polycondensation catalyst are selected from the group consisting of tetrabutyl titanate, tetraisopropyl titanate and tetraethyl titanate, and the esterification catalyst and the polycondensation catalyst are used in an amount that is 0.066%˜0.2% by weight of a total of the terephthalic acid, the isophthalic acid and the aliphatic dicarboxylic acid.

2. The method of claim 1, wherein the stabilizer is selected from trimethyl phosphate and triphenyl phosphite, and the stabilizer is used in an amount that is 0.05%˜0.15% by weight of the total of the terephthalic acid, the isophthalic acid and the aliphatic dicarboxylic acid,

3. The method of claim 1, wherein the antioxidant is selected from antioxidant 285 and antioxidant 1010, and the antioxidant is used in an amount that is 0.10%˜0.24% by weight of the total of the terephthalic acid, the isophthalic acid and the aliphatic dicarboxylic acid.
